(19) United States
(12) Patent Application Publication
(10) Pub. No.: US 2005/0035486 A1
(43) Pub. Date: Feb. 17, 2005

(54) Device and method for producing moulded bodies from thermoplastic polymers

(75) Inventors: Rainer Klostermann, Hockenheim (DE); Komrad Richter, Ludwigshafen (DE); Michael Senge, Weisenheim (DE); Herbert Wanjek, Freinsheim (DE); Werner Biffar, Frankenthal (DE)

Correspondence Address: KEIL & WEINKAUF, 1350 CONNECTICUT AVENUE, N.W., WASHINGTON, DC, 20036, US

(73) Assignee: BASF Aktiengesellschaft, 67056 Ludwigshafen (DE)

(21) Appl. No.: 10/501,874

(22) PCT Filed: Feb. 4, 2003
(86) PCT No.: PCT/EP03/01054

(30) Foreign Application Priority Data
Feb. 13, 2002 (DE) 102 06 103.3

(51) Int. Cl. B29C 47/00

(52) U.S. Cl. 264/176.1; 425/382.2; 425/308

(57) ABSTRACT

An apparatus suitable for producing shaped bodies comprising thermoplastic polymers from monomers which form such polymers in a batch process comprises a) at least one reactor suitable for the batchwise preparation of a melt of a thermoplastic polymer from monomers which form such a polymer, b) a piping system suitable as circulation line for the melt of the thermoplastic polymer and c) at least one apparatus suitable for the production of shaped bodies from the melt of a thermoplastic polymer, wherein the reactor or reactors a) is/are connected to the piping system b) and the apparatus or apparatuses c) is/are connected to the piping system b), and an apparatus for producing shaped bodies comprising thermoplastic polymers in such an apparatus.

The present invention relates to an apparatus and a process for producing shaped bodies comprising thermoplastic polymers with batchwise preparation of the thermoplastic polymers from monomers which form such thermoplastic polymers.

For the purposes of the present invention, thermoplastic polymers are polymers which have a melting point in accordance with ISO 11357-1 and 11357-3.

Processes for the batchwise preparation of thermoplastic polymers from monomers which form such thermoplastic polymers are generally known.

Thus, Kirk-Othmer, Encyclopedia of Chemical Technology, 4th Ed., Vol. 19, John Wiley & Sons, New York, 1996, pages 491-492 (bridging paragraph), or Fourné, Synthetische Fasern, Carl Hanser Verlag, Munich/Vienna, 1995, page 58, describe the preparation of polyamide 66 (nylon 66) from hexamethylenediammonium adipate in a batch process in an autoclave.

Fourné, Synthetische Fasern, loc cit, pages 46-47, discloses the preparation of polyamide 6 (nylon 6) from caprolactam in a batch process in an autoclave.

In both cases, the result is a melt of the corresponding thermoplastic polymer which is taken from the autoclave and usually fed directly into an apparatus for the production of shaped bodies, e.g. granules, from the polymer.

Since the polymer is prepared batchwise and the melt is therefore also taken from the autoclave discontinuously, the apparatus for the production of shaped bodies has to be started up when the melt is taken from the autoclave and shut down again afterwards. A disadvantage is that large amounts of off-specification product, in particular product having a brownish discoloration due to decomposition of the polymer, are obtained both during the start-up phase and also during the shutdown phase.

In addition, the apparatus for producing the shaped bodies is idle during the polymerization time.

It is well known that the time required for preparing the polymer melt from the monomers is very long compared to the time for taking off the polymer melt. According to Fourné, loc cit, pages 58-59, in the case of nylon 66 the total cycle time is about 7 hours and the time for taking off the melt is about 10 minutes and in the case of nylon 6, according to Fourné, loc cit, page 47, the preparation time is about 23 hours and the time for taking off the melt is about 60 minutes; if the apparatus for producing shaped bodies from the polymer is linked in a fixed manner with the autoclave concerned, the abovementioned times imply a utilization time for the appratus for producing the shaped bodies of about 4% in the case of nylon 6 and about 2.4% in the case of nylon 66.

It is known from Fourné, loc cit, page 47, that the apparatus for producing the shaped bodies can be constructed so as to be able to be moved among many autoclaves in order to avoid this disadvantage. This means that the apparatus can be moved from autoclave to autoclave, for example on rails. The apparatus is in each case pushed under the autoclave which is available for emptying and connected to this autoclave. The melt is then discharged from the autoclave into the apparatus and the shaped bodies are produced. After all the polymer has been taken from the autoclave, the apparatus is once again disconnected from the autoclave and pushed under the next autoclave available for emptying.

In this way, the utilization time of the apparatus can be increased, but this procedure is labor-intensive. In addition, the ability to move the apparatus does not solve the problem of the continual cyclic start-up and shutdown of the apparatus and the associated disadvantages described above.

To solve the problem associated with the continual cyclic start-up and shutdown of the apparatus, it has been proposed that the autoclaves firstly be emptied into a reservoir and the apparatus for producing the shaped bodies be supplied continuously from this reservoir.

In this case, it has been observed that deposits of decomposition products are formed in the reservoir, particularly in the upper region of the melt, due to the continual changes in level in the reservoir.

This is in agreement with Fourné, loc cit, page 47, 58-59, in particular page 61, according to whom the polymer melts are thermally unstable and this instability requires very short and uniform residence times, i.e. short melt lines having a small volume. A reservoir is diametrically opposed to these requirements.

It is an object of the present invention to provide an apparatus and a process which make it possible to prepare shaped bodies comprising thermoplastic polymers with batchwise preparation of the thermoplastic polymers from monomers which form such thermoplastic polymers while avoiding the above-mentioned disadvantages.

We have found that this object is achieved by an apparatus suitable for producing shaped bodies comprising thermoplastic polymers from monomers which form such polymers in a batch process, comprising
a) at least one reactor suitable for the batchwise preparation of a melt of a thermoplastic polymer from monomers which form such a polymer,
b) a piping system suitable as circulation line for the melt of the thermoplastic polymer and
c) at least one apparatus suitable for the production of shaped bodies from the melt of a thermoplastic polymer,
   wherein
the reactor or reactors a) is/are connected to the piping system b) and
the apparatus or apparatuses c) is/are connected to the piping system b),
   and an apparatus for producing shaped bodies comprising thermoplastic polymers from monomers which form such polymers in a batch process in such an apparatus, which comprises
a) preparing a melt of a thermoplastic polymer batchwise from monomers which form such a polymer in at least one reactor,
b) feeding the melt of the thermoplastic polymer obtained in step a) into a piping system suitable as circulation line for the melt of the thermoplastic polymer and moving it through the piping system at a mean average wall shear rate in the range from 0.1 to 100 s-¹ and a mean average flow velocity in the range from 0.1 to 100 cm/s,
c) taking the melt of the thermoplastic polymer from the piping system b) and producing shaped bodies from the thermoplastic polymer.

According to the present invention, the apparatus comprises at least one reactor suitable for the batchwise preparation of a melt of a thermoplastic polymer from monomers which form such a polymer.

If the apparatus comprises one such reactor, the apparatus of the present invention enables, in particular, the formation of deposits in lines which connect the reactor to at least one apparatus suitable for producing shaped bodies from the melt of a thermoplastic polymer to be effectively avoided.

If the apparatus comprises more than one reactor, for example 2, 3, 4, 5, 6, 7, 8, 9, 10, 11, 12, 13, 14, 15, 16, 17, 18, 19, 20 reactors, preferably 2, 3, 4, 5, 6, 7, 8, 9, 10, 11, 12 reactors, the apparatus of the present invention enables, in particular, the formation of deposits in lines which connect the reactor to at least one apparatus suitable for producing shaped bodies from the melt of a thermoplastic polymer to be effectively avoided.

In addition, operation of the reactors or groups of reactors can advantageously be staggered over time, in particular in such a way that the thermoplastic polymers are prepared in one reactor or a group of reactors, thermoplastic polymer is taken from another reactor or another group of reactors and, if appropriate, a further reactor or a further group of reactors is filled, and the functions of the reactors or groups of reactors are then rotated. In this way, continuous introduction of thermoplastic polymer into the piping system b) which is suitable as circulation line can be achieved in a particularly advantageous manner. Likewise, continuous tapping of thermoplastic polymer from the piping system b) which is suitable as circulation line can in this way be achieved in a particularly advantageous manner.

According to the present invention, the reactor a) is suitable for preparing a melt of a thermoplastic polymer. For the purposes of the present invention, a thermoplastic polymer is a polymer which has a melting point which can be determined in accordance with ISO 11357-1 and 11357-3.

Possible thermoplastic polymers are polymers which have functional groups in the main polymer chain or ones which have no functional groups in the main polymer chain, e.g. polyolefins such as polyethylene, polypropylene, polyisobutylene. The preparation of such polyolefins is known per se, for example from: Kirk-Othmer, Encyclopedia of Chemical Technology, 4th Ed., Vol. 17, John Wiley & Sons, New York, 1996, pages 705-839, or Ullmann's Encyclopedia of Industrial Chemistry, 5th Ed., Vol. A21, VCH Verlagsgesellschaft mbH, Weinheim, 1992, pages 487-577.

In a preferred embodiment, the thermoplastic polymer used can be a polymer whose main polymer chain comprises at least one recurring functional group of the structure
—(R¹)ₓ—C(O)—(R²)_{y}—
where
x, y: are each, independently of one another, 0 or 1, where x+y=1
R¹, R²: are each, independently of one another, oxygen or nitrogen bound into the main polymer chain, where two bonds of the nitrogen can advantageously be linked to the polymer chain and the third bond can bear a substituent selected from the group consisting of hydrogen, alkyl, preferably C₁-C₁₀-alkyl, in particular C₁-C₄-alkyl, e.g. methyl, ethyl, n-propyl, i-propyl, n-butyl, i-butyl, s-butyl, aryl, heteroaryl and —C(O)—, where the group —C(O)— may bear a further polymer chain, alkyl, preferably C₁-C₁₀-alkyl, in particular C₁-C₄-alkyl, e.g. methyl, ethyl, n-propyl, i-propyl, n-butyl, i-butyl, s-butyl, aryl, heteroaryl,
for example —N—C(O)—, —C(O)—N—, —O—C(O)—, —C(O)—O— or mixtures thereof, in particular —N—C(O)— or —C(O)—N— or their mixtures. In the case of —N—C(O)— or —C(O)—N— or their mixtures, the thermoplastic polymer is a polyamide.

For the purposes of the present invention, polyamides are homopolymers, copolymers, blends and grafted polymers comprising synthetic long-chain polyamides whose defining constituent is a recurring amide group in the main polymer chain. Examples of such polyamides are nylon 6 (polycaprolactam), nylon 6.6 (polyhexamethyleneadipamide), nylon 4.6 (polytetramethyleneadipamide), nylon 6.10 (polyhexamethylenesebacamide), nylon 7 (polyenantholactam), nylon 11 (polyundecanolactam), nylon 12 (polydodecanolactam). These polyamides are known by the generic name of nylon. Polyamides also include aramids (aromatic polyamides), e.g. polymetaphenyleneisophthalamide (NOMEX® fiber, U.S. Pat. No. 3,287,324) or polyparaphenyleneterephthalamide (KEVLAR® fiber, U.S. Pat. No. 3,671,542).

Polyamides can be produced by two principal methods.

Both in the polymerization from dicarboxylic acids and diamines and in the polymerization from amino acids or their derivatives such as aminocarboxylic nitriles, aminocarboxamides, aminocarboxylic esters or salts of aminocarboxylic acids, the amino and carboxyl end groups of the starting monomers or starting oligomers react with one another to form an amide group and water. The water can subsequently be removed from the polymer mass. In the polymerization from carboxamides, the amino and amide end groups of the starting monomers or starting oligomers react with one another to form an amide group and ammonia. The ammonia can subsequently be removed from the polymer mass. This polymerization reaction is usually referred to as polycondensation.

The polymerization from lactams as starting monomers or starting oligomers is usually referred to as polyaddition.

Such polyamides can be obtained from monomers selected from the group consisting of lactams, omega-aminocarboxylic acids, omega-aminocarboxylic nitriles, omega-aminocarboxamides, salts of omega-aminocarboxylic acids, omega-aminocarboxylic esters, equimolar mixtures of diamines and dicarboxylic acids, dicarboxylic acid/diamine salts, dinitriles and diamines or mixtures of such monomers by methods known per se, as are described, for example, in DE-A-14 95 198, DE-A-25 58 480, EP-A-129 196 or in: Polymerization Processes, Interscience, New York, 1977, pp. 424-467, in particular pp. 444-446.

Possible monomers are:
monomers or oligomers of a C₂₋C₂₀₋, preferably C₂₋C₁₈-arylaliphatic or preferably aliphatic lactam, e.g. enantholactam, undecanolactam, dodecanolactam or caprolactam,
monomers or oligomers of C₂₋C₂₀₋, preferably C₃₋C₁₈-aminocarboxylic acids, e.g. 6-aminocaproic acid, 11-aminoundecanoic acid, and also their dimers, trimers, tetramers, pentamers and hexamers, and also their salts such as alkali metal salts, for example lithium, sodium, potassium salts,
C₂₋C₂₀₋, preferably C₃₋C₁₈-aminocarboxylic nitriles, e.g. 6-aminocapronitrile, 11-aminoundecanenitrile,
monomers or oligomers of C₂₋C₂₀-amino acid amides, e.g. 6-aminocaproamide, 11-aminoundecanoamide and also their dimers, trimers, tetramers, pentamers or hexamers,
esters, preferably C₁-C₄-alkyl esters, e.g. methyl, ethyl, n-propyl, i-propyl, n-butyl, i-butyl, s-butyl esters, of C₂₋C₂₀₋, preferably C₃₋C₁₈-aminocarboxylic acids, e.g. 6-aminocaproic esters, for example methyl 6-aminocaproate, 11-aminoundecanoic esters, for example methyl 11-aminoundecanoate,
monomers or oligomers of a C₂₋C₂₀₋, preferably C₂₋C₁₂-alkylenediamine, e.g. tetramethylenediamine or preferably hexamethylenediamine, with a C₂₋C₂₀, preferably C₂₋C₁₄ aliphatic dicarboxylic acid or a mononitrile or dinitrile thereof, e.g. sebacic acid, dodecanedioic acid, adipic acid, sebaconitrile, decanedinitrile or adiponitrile, and also their dimers, trimers, tetramers, pentamers or hexamers,
monomers or oligomers of a C₂₋C₂₀, preferably C₂₋C₁₂-alkylenediamine, e.g. tetramethylenediamine or preferably hexamethylenediamine, with a C₈₋C₂₀, preferably C₈₋C₁₂ aromatic dicarboxylic acid or a derivative thereof, for example an acid chloride, e.g. 2,6-naphthalenedicarboxylic acid, preferably isophthalic acid or terephthalic acid, and also their dimers, trimers, tetramers, pentamers or hexamers,
monomers or oligomers of a C₂₋C₂₀, preferably C₂₋C₁₂-alkylenediamine, e.g. tetramethylenediamine or preferably hexamethylenediamine, with a C₉₋C₂₀, preferably C₉₋C₁₈-arylaliphatic dicarboxylic acid or a derivative thereof, for example an acid chloride, e.g. o-, m- or p-phenylenediacetic acid, and also their dimers, trimers, tetramers, pentamers or hexamers,
monomers or oligomers of a C₆₋C₂₀, preferably C₆₋C₁₀ aromatic diamine, e.g. m- or p-phenylenediamine, with a C₂₋C₂₀, preferably C₂₋C₁₄ aliphatic dicarboxylic acid or a mononitrile or dinitrile thereof, e.g. sebacic acid, dodecanedioic acid, adipic acid, sebaconitrile, decanedinitrile or adiponitrile, and also their dimers, trimers, tetramers, pentamers or hexamers,
monomers or oligomers of a C₆₋C₂₀, preferably C₆₋C₁₀ aromatic diamine, e.g. m- or p-phenylenediamine, with a C₈₋C₂₀, preferably C₈₋C₁₂ aromatic dicarboxylic acid or a derivative thereof, for example an acid chloride, e.g. 2,6-naphthalenedicarboxylic acid, preferably isophthalic acid or terephthalic acid, and also their dimers, trimers, tetramers, pentamers or hexamers,
monomers or oligomers of a C₆₋C₂₀, preferably C₆₋C₁₀ aromatic diamine, e.g. m- or p-phenylenediamine, with a C₉₋C₂₀, preferably C₉₋C₁₈ arylaliphatic dicarboxylic acid or a derivative thereof, for example an acid chloride, e.g. o-, m- or p-phenylenediacetic acid, and also their dimers, trimers, tetramers, pentamers or hexamers,
monomers or oligomers of a C₇₋C₂₀, preferably C₈₋C₁₈ arylaliphatic diamine, e.g. m- or p-xylylenediamine, with a C₂₋C₂₀, preferably C₂₋C₁₄ aliphatic dicarboxylic acid or a mononitrile or dinitrile thereof, e.g. sebacic acid, dodecanedioic acid, adipic acid, sebaconitrile, decanedinitrile or adiponitrile, and also their dimers, trimers, tetramers, pentamers or hexamers,
monomers or oligomers of a C₇₋C₂₀, preferably C₈₋C₁₈ arylaliphatic diamine, e.g. m- or p-xylylenediamine, with a C₆₋C₂₀, preferably C₆₋C₁₀ aromatic dicarboxylic acid or a derivative thereof, for example an acid chloride, e.g. 2,6-naphthalenedicarboxylic acid, preferably isophthalic acid or terephthalic acid, and also their dimers, trimers, tetramers, pentamers or hexamers,
monomers or oligomers of a C₇₋C₂₀, preferably C₈₋C₁₈ arylaliphatic diamine, e.g. m- or p-xylylenediamine, with a C₉₋C₂₀, preferably C₉₋C₁₈ arylaliphatic dicarboxylic acid or a derivative thereof, for example an acid chloride, e.g. o-, m- or p-phenylenediacetic acid, and also their dimers, trimers, tetramers, pentamers or hexamers, and also homopolymers, copolymers, mixtures and grafted polymers of such starting monomers or starting oligomers.

In a preferred embodiment, caprolactam is used as lactam, tetramethylenediamine, hexamethylenediamine, m-xylylenediamine, p-xylylenediamine or a mixture thereof is used as diamine and adipic acid, sebacic acid, dodecanedioic acid, terephthalic acid, isophthalic acid or a mixture thereof is used as dicarboxylic acid. Particular preference is given to caprolactam as lactam, hexamethylenediamine or m-xylylenediamine as diamine and adipic or terephthalic acid as dicarboxylic acid, or a mixture thereof, in particular hexamethylenediammonium adipate.

Particular preference is given to starting monomers or starting oligomers which on polymerization lead to the polyamides nylon 6, nylon 6.6, nylon 4.6, nylon 6.10, nylon 6.12, nylon 7, nylon 11, nylon 12, poly-m-xylyleneadipamide or the aramids polymetaphenyleneisophthalamide or poly-paraphenyleneterephthalamide, in particular to nylon 6 or nylon 6.6, particularly preferably nylon 6.6.

In a preferred embodiment, one or more chain regulators can be used in the preparation of the polyamides. Advantageous chain regulators are compounds which have two, three or four, in the case of systems in the form of fibers preferably two, amino groups which are reactive in polyamide formation or one or more, e.g. two, three or four, in the case of systems in the form of fibers preferably two, carboxyl groups which are reactive in polyamide formation.

In the first case, the products obtained are polyamides where the monomers used for preparing the polyamide have a greater number of amine groups or their equivalents used to form the polymer chain than carboxyl groups or their equivalents used to form the polymer chain.

In the second case, the products obtained are polyamides where the monomers used for preparing the polyamide have a greater number of carboxyl groups or their equivalents used to form the polymer chain than amine groups or their equivalents used to form the polymer chain.

Compounds which can advantageously be used as chain regulators are monocarboxylic acids such as alkanecarboxylic acids, preferably having from 1 to 20 carbon atoms including the carboxyl group, for example acetic acid or propionic acid, benzenemonocarboxylic or naphthalenemonocarboxylic acids, for example benzoic acid, dicarboxylic acids such as C₄-C₁₀-alkanedicarboxylic acids, for example adipic acid, azelaic acid, sebacic acid, dodecanedioic acid, C₅-C₈-cycloalkanedicarboxylic acids, for example cyclohexane-1,4-dicarboxylic acid, benzene or naphthalenedicarboxylic acids, for example terephthalic acid, isophthalic acid, naphthalene-2,6-dicarboxylic acid, C₂₋C₂₀-, preferably C₂₋C₁₂-alkylamines, e.g. cyclohexylamine, C₆₋C₂₀, preferably C₆₋C₁₀ aromatic monoamines, e.g. aniline, or C₇₋C₂₀, preferably C₈₋C₁₈ arylaliphatic monoamines, e.g. benzylamine, diamines, such as C₄-C₁₀-alkanediamines, for example hexamethylenediamine.

The chain regulators can be unsubstituted or substituted, for example by aliphatic groups, preferably C₁-C₈-alkyl groups such as methyl, ethyl, i-propyl, n-propyl, n-butyl, i-butyl, s-butyl, n-pentyl, n-hexyl, n-heptyl, n-octyl, 2-ethylhexyl, OH, ═O, C₁-C₈-alkoxy, COOH, C₂-C₆-carbalkoxy, C₁-C₁₀-acyloxy or C₁-C₈-alkylamino, sulfonic acids or their salts, e.g. alkali metal or alkaline earth metal salts, cyano or halogens such as fluorine, chlorine, bromine. Examples of substituted chain regulators are sulfoisophthalic acid, its alkali metal or alkaline earth metal salts, e.g. lithium, sodium or potassium salts, sulfoisophthalic esters, for example esters with C₁-C₁₆-alkanols, or sulfoisophthalic monoamides or diamides, in particular with monomers which bear at least one amine group and are suitable for forming polyamides, e.g. hexamethylenediamine or 6-aminocaproic acid.

A chain regulator can advantageously be used in amounts of at least 0.01 mol %, preferably at least 0.05 mol %, in particular at least 0.2 mol %, based on 1 mol of acid amide groups of the polyamide.

A chain regulator can advantageously be used in amounts of not more than 1.0 mol %, preferably not more than 0.6 mol %, in particular not more than 0.5 mol %, based on 1 mol of acid amide groups of the polyamide.

In an advantageous embodiment, the polyamide can comprise a sterically hindered piperidine derivative which is chemically bound to the polymer chain as chain regulator. In this case, a single sterically hindered piperidine derivative or a mixture of such sterically hindered piperidine derivatives can be present in the polyamide.

As sterically hindered piperidine derivative, preference is given to compounds of the formula 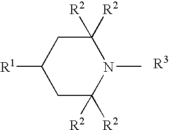
where
R¹ is a functional group which is capable of amide formation with the polymer chain of the polyamide,
   preferably an —(NH)R⁵ group, where R⁵ is hydrogen or C₁-C₈-alkyl, or a carboxyl group or a carboxyl derivative or a —(CH₂)ₓ(NH)R⁵ group, where x is from 1 to 6 and R⁵ is hydrogen or C₁-C₈-alkyl, or a —(CH₂)_{y}COOH group, where y is from 1 to 6, or a —(CH₂)_{y}COOH acid derivative, where y is from 1 to 6, in particular an —NH₂ group,
R² is an alkyl group, preferably a C₁-C₄-alkyl group such as methyl, ethyl, n-propyl, i-propyl, n-butyl, i-butyl, s-butyl, in particular a methyl group,
R³ is hydrogen, C₁-C₄-alkyl or O—R⁴, where R⁴ is hydrogen C₁-C₇-alkyl,
   in particular hydrogen.

In such compounds, the tertiary or in particular secondary amine groups of the piperidine ring systems usually do not react because of steric hindrance.

A particularly preferred sterically hindered piperidine derivative is 4-amino-2,2,6,6-tetramethylpiperidine.

The sterically hindered piperidine derivative can advantageously be used in amounts of at least 0.01 mol %, preferably at least 0.05 mol %, in particular at least 0.1 mol %, based on 1 mol of acid amide groups of the polyamide.

The sterically hindered piperidine derivative can advantageously be used in amounts of not more than 0.8 mol %, preferably not more than 0.6 mol %, in particular not more than 0.4 mol %, based on 1 mol of acid amide groups of the polyamide.

The polymerization or polycondensation by the process of the present invention can be carried out in the presence of at least one pigment. Preferred pigments are titanium dioxide, preferably in the anatase modification, or color-imparting inorganic or organic compounds. The pigments are preferably used in an amount of from 0 to 5 parts by weight, in particular from 0.02 to 2 parts by weight, in each case based on 100 parts by weight of polyamide. The pigments can be fed into the reactor together with the starting materials or separately therefrom.

The polyamide can further comprise organic or inorganic stabilizers, but is preferably free of such stabilizers.

Advantageous thermoplastic polyamides in which a sterically hindered piperidine derivative which is chemically bound to the polymer chain is present and processes for preparing such polyamides are described, for example, in WO 95/28443, WO 97/05189, WO 98/50610, WO 99/46323, WO 99/48949, EP-A-822 275, EP-A-843 696 and the German patent applications 10030515.6, 10030512.1 and 10058291.5.

Reactors for the batchwise preparation of such thermoplastic polyamides from monomers forming such polyamides and also the parameters customary for this purpose, e.g. pressure, temperature and content of additives such as water, are generally known, for example from Fourné, loc cit, pages 46-47, section 2.2.3.5., and 58-60, section 2.2.4.2., whose contents are hereby incorporated by reference into the present description.

The preparation of the polymer in step a) can be carried out at a pressure above ambient pressure, at ambient pressure or at a pressure below ambient pressure (“vacuum polymerization”).

A pressure of not more than 3 MPa, preferably not more than 2.5 MPa, in particular not more than 20 MPa, has been found to be particularly advantageous for the preparation of the polymer in a).

In vacuum polymerization, the lower limit for the pressure is generally set by the vapor pressure of the reaction mixture under the reaction conditions, e.g. at the respective temperature and composition of the reaction mixture.

A pressure of at least 0.01 MPa (absolute), preferably at least 0.1 MPa (corresponding to ambient pressure), has been found to be particularly advantageous for the preparation of the polymer in a). Furthermore, a temperature in the range from 100 to 380° C., preferably from 120 to 350° C., in particular from 145 to 295° C., is advantageous for the preparation of the polymer.

As reactors, pressure-rated vessels, e.g. autoclaves, have been found to be advantageous. Such vessels may contain devices which promote mixing of the charge in the reactor, e.g. wall stirrers, blade stirrers, turbines, static mixers, injectors.

According to the present invention, a melt of the thermoplastic polymer formed in a) is transferred into a piping system suitable as circulation system for the melt of the thermoplastic polymer, for example via a pipe.

Here, a very short connection between a) and b) has been found to be particularly advantageous.

The piping system can comprise a single pipe which forms a circuit or a plurality of such pipes. It is likewise possible for at least one pipe to have a branch so that the melt flows through varying number of pipes during circulation.

In an advantageous embodiment, the mean average pipe diameter in the piping system b) between the first reactor a) and the last apparatus c) viewed in the flow direction can be equal to or greater than the mean average pipe diameter between the last apparatus c) and the first reactor a) viewed in the flow direction. In the piping system b), the ratio of the mean average pipe diameter between the first reactor a) and the last apparatus c) viewed in the flow direction to the mean average pipe diameter between the last apparatus c) and the first reactor a) viewed in the flow direction is preferably in the range from 1:1 to 10:1, in particular in the range from 1:1 to 5:1.

According to the present invention, the melt of the thermoplastic polymer obtained in step a) travels along in the piping system b) at a mean average wall shear rate in the range from 0.1 to 100 s-¹, preferably from 0.4 to 50 s-¹, in particular from 1 to 10 s-¹, where the wall shear rate is determined according to the equation
dv/dr=(4*V)/(π*r³)
where:
v: flow velocity
V: flow volume
r: radius
   and at a mean average flow velocity in the range from 0.1 to 100 cm/s, preferably from 0.4 to 50 cm/s, in particular from 1 to 10 cm/s.

The temperature of the melt of the thermoplastic polymer in the piping system is advantageously at least 0° C., preferably at least 10° C., above the melting point of the thermoplastic polymer, determined in accordance with ISO 11357-1 and 11357-3.

The temperature of the melt of the thermoplastic polymer in the piping system is advantageously not more than 60° C., preferably not more than 40° C., above the melting point of the thermoplastic polymer, determined in accordance with ISO 11357-1 and 11357-3. The movement of the melt of the thermoplastic polymer in the piping system can be generated purely thermally by means of different temperatures and thus density differences in the melt in the piping system.

It has been found to be advantageous for the piping system to additionally have one or more conveying devices suitable for moving the melt of the thermoplastic polymer in the longitudinal direction of the piping system, preferably one or more pumps such as gear pumps, worm pumps, screw pumps, disk pumps, extruders, piston pumps, centrifugal pumps.

Particularly advantageous conveying devices and the parameters suitable for achieving the average mean shear rate and the mean average flow velocity prescribed according to the present invention can easily be determined by means of a few simple preliminary tests.

Furthermore, it has been found to be advantageous for the piping system to additionally have one or more filtration devices in b). In the case of a filtration device and a conveying device, it is possible for the filtration device to be located downstream (based on the direction of flow of the melt) of the conveying device, but is preferably located upstream of the conveying device.

Here, the filtration devices known per se for the filtration of polymer melts can be used in a customary manner. Particularly advantageous filtration devices can easily be determined by means of a few simple preliminary tests.

According to the present invention, the apparatus comprises at least one apparatus which is suitable for the production of shaped bodies from the melt of the thermoplastic polymer and is connected to the piping system b), preferably via a pipe.

It has been found to be particularly advantageous to keep the connection between c) and b) very short.

It has been found to be advantageous for the apparatus of the present invention to additionally have one or more conveying devices suitable for moving the melt of the thermoplastic polymer from b) to c), preferably one or more pumps such as gear pumps, worm pumps, screw pumps, disk pumps, extruders, piston pumps, centrifugal pumps.

Particularly advantageous conveying devices can easily be determined by means of a few simple preliminary tests.

Furthermore, it has been found to be advantageous for the apparatus of the present invention to additionally have one or more filtration devices between b) and c). In the case of a filtration device and a conveying device between b) and c), the filtration device can be located upstream (based on the direction of flow of the melt) of the conveying device, but is preferably located downstream of the conveying device.

Here, the filtration devices known per se for the filtration of polymer melts can be used in a customary manner. Particularly advantageous filtration devices can easily be determined by means of a few simple preliminary tests.

For the purposes of the present invention, shaped bodies are solid substances which have a predominantly one-dimensional shape, e.g. fibers, a predominantly two-dimensional shape, e.g. films, or a three-dimensional shape, e.g. pellets or injection-molded parts.

Accordingly, advantageous apparatuses for the production of such shaped bodies are a spinning apparatus, an apparatus for producing films, e.g. a film blowing apparatus or a film drawing apparatus, or a granulator. It is also possible for a plurality of identical or different machines of this type to be connected to the piping system b).

Such apparatuses and processes for producing the respective shaped bodies are known per se, for example melt spinning units and blowing shafts from Fourné, loc cit, pages 273-368, apparatuses for film production from WO 98/5716, WO 98/24324 or EP-A-870 604 and granulators, preferably underwater granulators or underwater pressure granulators, from German patent application number 10037030.6.

1. An apparatus suitable for producing shaped bodies comprising thermoplastic polymers from monomers which form such polymers in a batch process, comprising
a) at least one reactor suitable for the batchwise preparation of a melt of a thermoplastic polymer from monomers which form such a polymer,
b) a piping system suitable as circulation line for the melt of the thermoplastic polymer and
c) at least one apparatus suitable for the production of shaped bodies from the melt of a thermoplastic polymer,
wherein
the reactor or reactors a) is/are connected to the piping system b) and
the apparatus or apparatuses c) is/are connected to the piping system b).

2. An apparatus as claimed in claim 1, wherein the reactor or reactors used in a) is/are suitable for the reaction at a pressure in the range from 0 to 3 MPa and at a temperature in the range from 100 to 380_C.

3. An apparatus as claimed in claim 1, wherein the piping system b) additionally has a conveying device suitable for moving the melt of the thermoplastic polymer in the longitudinal direction of the piping system.

4. An apparatus as claimed in claim 1, wherein a granulator is used as apparatus c).

5. An apparatus as claimed in claim 1, wherein a spinning apparatus is used as apparatus c).

6. An apparatus as claimed in claim 1, wherein an apparatus for producing a film is used as apparatus c).

7. An apparatus as claimed in claim 1, wherein the mean average pipe diameter in the piping system b) between the first reactor a) and the last apparatus c) viewed in the flow direction is equal to or greater than the mean average pipe diameter between the last apparatus c) and the first reactor a) viewed in the flow direction.

8. An apparatus as claimed in claim 1, wherein the ratio of the mean average pipe diameter in the piping system b) between the first reactor a) and the last apparatus c) viewed in the flow direction to the mean average pipe diameter between the last apparatus c) and the first reactor a) viewed in the flow direction is in the range from 1:1 to 10:1.

9. An apparatus for producing shaped bodies comprising thermoplastic polymers from monomers which form such polymers in a batch process in an apparatus as claimed in claim 1, which comprises
a) preparing a melt of a thermoplastic polymer batchwise from monomers which form such a polymer in at least one reactor,
b) feeding the melt of the thermoplastic polymer obtained in step a) into a piping system suitable as circulation line for the melt of the thermoplastic polymer and moving it through the piping system at a mean average wall shear rate in the range from 0.1 to 100 s-¹ and a mean average flow velocity in the range from 0.1 to 100 cm/s,
c) taking the melt of the thermoplastic polymer from the piping system b) and producing shaped bodies from the thermoplastic polymer.

10. A process as claimed in claim 9, wherein monomers selected from the group consisting of adipic acid, hexamethylenediamine, terephthalic acid, xylylenediamine, hexamethylenediammonium adipate, caprolactam and mixtures thereof are used in step a).

11. A process as claimed in claim 9, wherein hexamethylenediammonium adipate is used as monomer in step a).

12. A process as claimed in claim 9, wherein the temperature of the melt of the thermoplastic polymer in the piping system used in step b) is from 0 to 60_C above the melting point of the thermoplastic polymer determined in accordance with ISO 11357-1 and 11357-3.

13. A process as claimed in claim 1, wherein, in step c), melt of the thermoplastic polymer is taken continuously from the piping system.
